(19) United States
(12) Patent Application Publication
(10) Pub. No.: US 2023/0316363 A1
(43) Pub. Date: Oct. 5, 2023

(54) SYSTEM AND METHOD FOR CREATING CUSTOM FOOTWEAR

(71) Applicant: Orpyx Medical Technologies Inc., Calgary (CA)

(72) Inventors: SAMUEL CARL WILLIAM BLADES, Victoria (CA); OMAR SULEMAN, Vancouver (CA); REBECCA MIN WYTSMA, Calgary (CA)

(21) Appl. No.: 18/190,677

(22) Filed: Mar. 27, 2023

Related U.S. Application Data
(60) Provisional application No. 63/326,101, filed on Mar. 31, 2022.

(51) Int. Cl. G06Q 30/0601; G06Q 30/0283; G06Q 50/04; G06N 20/20

(52) U.S. Cl. CPC G06Q 30/0621; G06Q 30/0283; G06Q 50/04; G06N 20/20

(57) ABSTRACT

A system, method and computer program product for creating a custom footwear article design. A plurality of sensor readings are obtained from a corresponding plurality of sensors provided in a wearable device while the wearable device is worn by a user while also wearing a test footwear article. At least one customization criterion can be identified for the user. A plurality of biomechanical contributing factor values can be determined for the user based on the sensor readings. A cost value can be determined based on differences between the biomechanical contributing factor values and a plurality of preferred biomechanical contributing factor values. A footwear article design is optimized by adjusting at least one characteristic of the test footwear article to minimize the cost value. The custom footwear article design can be identified as the footwear article design corresponding to a minimum cost value.

### CROSS-REFERENCE TO RELATED APPLICATIONS

This application claims the benefit of priority of U.S. Provisional Application No. 63/326,101 filed Mar. 31, 2022, which is incorporated herein by reference.

### FIELD

This document relates to systems and methods for processing data from sensors monitoring human movement or human activity. In particular, this document relates to creating a custom footwear article design using force sensor data.

### BACKGROUND

U.S. Pat. No. 9,817,439 (Gosieski Jr. et al.) discloses a system, method and device that employs sensor arrangements and an e-system in designing, manufacturing, and monitoring custom human-interfacing devices.

US Patent Publication No. 2016/0367191 (Esposito et al.) discloses sensing devices including flexible and stretchable pressure sensors that may be associated with or incorporated in garments intended to be worn against a body surface (directly or indirectly), or may be associated with other types of flexible substrates. Systems and methods for storing, communicating, processing, analyzing and displaying data collected by sensor components for remote monitoring of conditions at or near body surfaces are also disclosed. Sensors and sensor systems provide substantially real-time feedback relating to current body conditions and may provide user-specific feedback relating to gait and footwear fit and performance, facilitating improved footwear matching to individual users and improved footwear design and manufacturing, and enabling early intervention when conditions indicate intervention is appropriate.

### SUMMARY

The following summary is intended to introduce the reader to various aspects of the detailed description, but not to define or delimit any invention.

A system, method and computer program product for creating custom designs of footwear articles is provided. Biomechanical data can be obtained from a user wearing a test footwear article to perform one or more activities. The biomechanical data can be obtained using sensors positioned to measure and monitor data relating to movement or activity of the user while wearing the test footwear article. One or more customization criteria can be identified for the user. The biomechanical data obtained from the user can be used to evaluate biomechanical contributing factors related to the one or more customization criteria. Based on the evaluation of the biomechanical contributing factors, an updated footwear article design can be generated by adjusting one or more characteristics of the footwear article. The characteristics can be adjusted so that the biomechanical data obtained from the user is expected to more closely match preferred or ideal values of the biomechanical contributing factors related to the one or more customization criteria. The footwear article design can be customized to improve a performance level, reduce discomfort and/or reduce a risk of injury for the user when performing specified activities.

According to some aspects, a method for creating a custom footwear article design includes: obtaining a plurality of sensor readings from a corresponding plurality of sensors provided in a wearable device, and while the wearable device is worn by a user while also wearing a test footwear article; identifying at least one customization criterion for the user; determining a plurality of biomechanical contributing factor values for the user based on the sensor readings; determining a cost value based on at least one difference between the plurality of biomechanical contributing factor values and a plurality of preferred biomechanical contributing factor values; optimizing a footwear article design by adjusting at least one characteristic of the test footwear article to minimize the cost value; and identifying the custom footwear article design as the footwear article design corresponding to a minimum cost value.

The method can include manufacturing the custom footwear article using the custom footwear article design.

The method can include identifying a preferred existing footwear article similar to the custom footwear article; and outputting an indication of the preferred existing footwear article.

Each biomechanical contributing factor value can have an associated weight representing a level of contribution of a corresponding biomechanical contributing factor to the at least one customization criterion; each difference of the at least one difference is used to determine a factor-specific error value; and the cost value can be determined by weighing each factor-specific error value according to the associated weight for the corresponding biomechanical contributing factor.

The design of the footwear article can be optimized iteratively using finite element analysis of a model of the design of the footwear article.

The plurality of sensors can include a force-sensing element.

The plurality of sensors can include an inertial measurement unit.

The biomechanical contributing factor values can include at least one of: a pressure value, a ground reaction force value, a center of pressure value, a foot contact event value, a stride time value, a ground contact time value, a swing time value, a rate of pronation value, a rate of force development value, a foot strike index value, a foot orientation value, a mid-stance value, a stride length value, a stride velocity value, a joint force value, a joint moment value, or a power value.

The at least one characteristic can include at least one of a material hardness, a material density, a material stiffness, a material texture, a footwear shape, footwear contouring, a footwear size, a footwear component number, a footwear component size, a footwear component location, or a toebox volume.

The plurality of preferred biomechanical contributing factor values can be specific to the at least one customization criterion.

The at least one customization criterion can include a specified activity and a specified customization metric.

The at least one customization criterion can include a specified customization metric, and the specified customization metric can be one of an injury risk metric, a performance level metric, and a discomfort level metric.

The plurality of preferred biomechanical contributing factor values can be defined based on an analysis of a machine learning model trained to determine a value of the specified customization metric. The analysis of the machine learning model can identify the preferred biomechanical contributing factor values as those biomechanical contributing factor values that contribute to a desired metric value of the specified customization metric.

The machine learning model can be trained using training data that includes training sensor readings obtained from a plurality of training users performing one or more specified activities. The plurality of users can be associated with different metric values of the specified customization metric.

The machine learning model can be trained using training sensor readings obtained from the plurality of training users performing a single specified activity.

The training data can include training user anthropometric data and training user wellness data for the plurality of training users.

The wearable device can be footwear.

The footwear can be an insole.

The footwear can be a sock.

According to some aspects, a system for creating a custom footwear article design includes: a plurality of sensors mountable to a user, wherein the plurality of sensors is configured to obtain a plurality of sensor readings from the user while the user is also wearing a test footwear article; a memory configured to store the plurality of sensor readings and a plurality of preferred biomechanical contributing factor values; and one or more processors configured to: identify at least one customization criterion for the user; determine a plurality of biomechanical contributing factor values for the user based on the sensor readings; determine a cost value based on at least one difference between the plurality of biomechanical contributing factor values and the plurality of preferred biomechanical contributing factor values; optimize a footwear article design by adjusting at least one characteristic of the test footwear article to minimize the cost value; and identify the custom footwear article design as the footwear article design corresponding to a minimum cost value.

The one or more processors can be configured to: identify a preferred existing footwear article similar to the custom footwear article; and output an indication of the preferred existing footwear article.

The one or more processors can be configured to: associate each biomechanical contributing factor value with an associated weight representing a level of contribution of a corresponding biomechanical contributing factor to the at least one customization criterion; use each difference of the at least one difference to determine a factor-specific error value; and determine the cost value by weighing each factor-specific error value according to the associated weight for the corresponding biomechanical contributing factor.

The one or more processors can be configured to optimize the design of the footwear article iteratively using finite element analysis of a model of the design of the footwear article.

The plurality of sensors can include a force-sensing element.

The plurality of sensors can include an inertial measurement unit.

The biomechanical contributing factor values can include at least one of: a pressure value, a ground reaction force value, a center of pressure value, a foot contact event value, a stride time value, a ground contact time value, a swing time value, a rate of pronation value, a rate of force development value, a foot strike index value, a foot orientation value, a mid-stance value, a stride length value, a stride velocity value, a joint force value, a joint moment value, or a power value.

The at least one characteristic can include at least one of a material hardness, a material density, a material stiffness, a material texture, a footwear shape, footwear contouring, a footwear size, a footwear component number, a footwear component size, a footwear component location, or a toebox volume.

The plurality of preferred biomechanical contributing factor values can be specific to the at least one customization criterion.

The at least one customization criterion can include a specified activity and a specified customization metric.

The one or more processors can be configured to identify the at least one customization criterion to include a specified customization metric, and the specified customization metric can be one of an injury risk metric, a performance level metric, and a discomfort level metric.

The plurality of preferred biomechanical contributing factor values can be defined based on an analysis of a machine learning model trained to determine a value of the specified customization metric. The analysis of the machine learning model can identify the preferred biomechanical contributing factor values as those biomechanical contributing factor values that contribute to a desired metric value of the specified customization metric.

The machine learning model can be trained using training data that includes training sensor readings obtained from a plurality of training users performing one or more specified activities. The plurality of users can be associated with different metric values of the specified customization metric.

The machine learning model can be trained using training sensor readings obtained from the plurality of training users performing a single specified activity.

The training data can include training user anthropometric data and training user wellness data for the plurality of training users.

The wearable device can be footwear.

The footwear can be an insole.

The footwear can be a sock.

According to some aspects, there is provided a non-transitory computer readable medium storing computer-executable instructions, which, when executed by a computer processor, cause the computer processor to carry out a method for creating a custom footwear article design. The method includes obtaining a plurality of sensor readings from a corresponding plurality of sensors provided in a wearable device, and while the wearable device is worn by a user while also wearing a test footwear article; identifying at least one customization criterion for the user; determining a plurality of biomechanical contributing factor values for the user based on the sensor readings; determining a cost value based on at least one difference between the plurality of biomechanical contributing factor values and a plurality of preferred biomechanical contributing factor values; optimizing a footwear article design by adjusting at least one characteristic of the test footwear article to minimize the cost value; and identifying the custom footwear article design as the footwear article design corresponding to a minimum cost value.

The non-transitory computer readable medium can store computer-executable instructions, which, when executed by a computer processor, cause the computer processor to carry out the method for creating a custom footwear article design, where the method is described herein.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example of a system for creating a custom footwear article design;

FIG. 2 is a diagram illustrating an example of a wearable device incorporating a sensing unit that can be used in the system of FIG. 1;

FIG. 3 is a flowchart illustrating an example of a method for creating a custom footwear article design;

FIG. 4 is a flowchart illustrating an example of a method for optimizing a footwear article design that can be used with the method of FIG. 3; and

FIG. 5 is a flowchart illustrating an example of a method for determining biomechanical contributing factors that can be used with the method of FIG. 3.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are systems, methods and devices for creating custom designs for footwear articles such as footwear and footwear accessories. The systems, methods and devices can be used to determine a custom design of a footwear article for a user.

The term “footwear article” as used herein generally refers to any device or clothing that interfaces with the foot of an individual. Examples of footwear articles can include, but are not limited to, daily-living footwear (e.g. sneakers, boots, high heels, socks etc.), athletic footwear (e.g. cleats, skates, ski boots, pointe shoes etc.), structural medical devices (e.g. casts, braces, compression socks etc.), and footwear inserts (e.g. insoles, orthotics etc.).

The systems, methods and devices described herein can evaluate biomechanical data relating to the use of a footwear article by a user. The biomechanical data can be determined based on sensor readings acquired in relation to the use of the footwear article to perform one or more activities. The systems, methods and devices described herein can be used to determine a design for a footwear article using at least one customization criterion.

For example, the systems, methods and devices described herein can be used to create a custom footwear article design for a variety of different specified activities. Examples of specified activities can include sports/athletic activities, occupational activities, daily living activities, military activities and so forth.

Alternatively or in addition, the systems, methods and devices described herein can be used to create a custom footwear article design for a variety of different specified customization metrics. Examples of specified customization metrics can include an injury risk metric, a performance level metric, a discomfort level metric and so forth.

The sensor readings can be obtained from a plurality of sensors positioned in a wearable device worn by the user while the user also wears a footwear article to perform one or more activities. The sensors can be attached to, or contained within, wearable devices to measure and monitor data relating to movement or activity of an individual. The measured data from the sensors can be used to determine values of biomechanical contributing factors relating to the use of the footwear article by the user. The biomechanical contributing factor values can be used to optimize the design of the footwear article according to a specified customization criterion.

The sensors can include force sensors and can be provided in a wearable device in the form of an insole of a shoe or within the footwear worn by the individual. The force data acquired by the force sensors can be used to determine the level of force applied by an individual's foot when performing various activities such as walking, running, or jumping for example. This force data can be used to derive additional force derivatives or force-based metrics, such as the force output, mean force or the peak force applied by the foot. The force data, and other data derived therefrom, can be used to determine values of biomechanical contributing factors of a footwear article also worn by the individual.

The biomechanical contributing factors can be factors identified as being related to the specified customization criterion. The values of the biomechanical contributing factors can be used to modify the design of the footwear article in order to determine an optimized design for the footwear article. For example, the biomechanical contributing factor values can be compared to preferred or ideal values determined for the at least one specified customization criterion. A cost value can be determined based on the comparison. The design of the footwear article can be modified to optimize the cost value. A custom footwear article design can be identified as the footwear article design corresponding to a minimum cost value.

Optionally, a preferred existing footwear article can be identified based on the custom footwear article design. The preferred existing footwear article may be identified from amongst a plurality of potential existing footwear articles. The preferred existing footwear article may be identified as the potential existing footwear article that most closely matches the custom footwear article design.

The preferred existing footwear article can then be recommended to the user. This may reduce the cost to the user, by identifying an existing footwear article that most closely matches the custom design identified for the user.

Alternatively or in addition, a custom footwear article can be manufactured for the user according to the custom footwear article design. This may provide a user with a custom footwear article that is configured to enable the user to achieve desired biomechanical data corresponding to the customization criterion for one or more specified activities.

Various different customization criteria can be specified for a user. For example, the at least one customization criterion can include a specified customization metric. Various different types of specified customization metrics may be used.

For example, the specified customization metric can be defined to include an injury risk metric. The injury risk metric can be defined to identify biomechanical factors that contribute to a probability and/or severity of injury for an individual while wearing the footwear article. The design of the footwear article can then be optimized by adjusting the characteristics of the footwear article to reduce the probability and/or severity of injury.

An injury risk metric may be a specific injury risk metric defined based on the probability and/or severity of a specific injury (e.g. an anterior cruciate ligament (ACL) tear risk metric). Alternatively, an injury risk metric can be defined as a general injury risk metric defined based on the probability and/or severity of any injury (e.g. a lower-limb injury risk metric).

Alternatively or in addition, the specified customization metric can be defined to include a performance level metric. The performance level metric can be defined to identify biomechanical factors that contribute to the level of performance for an individual while wearing the test article. The design of the footwear article can then be optimized by adjusting the characteristics of the footwear article to improve the expected level of performance for the user.

Alternatively or in addition, the specified customization metric can be defined to include a discomfort level metric. The discomfort level metric can be defined to identify biomechanical factors that contribute to the level of discomfort that an individual will experience while wearing the test article to perform specified activities. The design of the footwear article can then be optimized by adjusting the characteristics of the footwear article to improve the expected comfort level (i.e. to reduce the expected discomfort level) for the user.

The footwear article can be customized as an activity-specific custom footwear article. Accordingly, the at least one customization criterion can include a specified activity criterion. That is, the design of the footwear article can be optimized for use in performing a specified activity set identified by the specified activity criterion.

The specified activity set may be defined as a particular sport activity (e.g. soccer, football, baseball, hockey, skiing, and so forth). Alternatively or in addition, the specified activity set may be defined based on particular movements (e.g. running, walking, jumping etc.). Optionally, the definition of a particular sport activity may include, or be defined as, particular movements that are associated with a sport activity.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object-oriented programming. Accordingly, the program code may be written in any suitable programming language such as Python or C, for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates in general to a system, method, and device that can be used to customize the design of a footwear article for an individual. The design of the footwear article can be individually customized based on sensor readings obtained from the individual while performing one or more activities while also wearing a test footwear article. The design of the test footwear article can be assessed relative to at least one customization criterion using force sensor data from a plurality of force sensors positioned underfoot while the user is wearing the test article.

The force sensor data can be used to determine force values for the user while performing one or more activities. Directly measuring the force (or pressure) applied by an individual using underfoot force sensors (as opposed to deriving the force data from other sensors such as accelerometers) can contribute to more accurate calculations of force-derived biomechanical contributing factor values. Directly measuring the force applied by an individual using underfoot force sensors also allows force to be measured during static conditions (e.g. while a user is standing or performing a wall-sit). As used herein, the term “force” is used broadly and can refer to raw force (i.e. with units of N), or pressure resulting from a raw force (i.e. with units of N/m²).

Biomechanical data can be synthesized from the sensor readings obtained while the user is wearing the test footwear article. The biomechanical data can be used to determine values of biomechanical contributing factors that result from the use of the footwear article by the user. The values of these biomechanical contributing factors can be compared to preferred values that are determined for the corresponding customization criterion. Differences (e.g. percent differences) between the measured values and the preferred values can be used to generate one or more error or cost values for the footwear article design. The design of the footwear article can then be modified in order to reduce or minimize the error or cost values.

Various different types of biomechanical data can be synthesized from the sensor readings. Examples of biomechanical data that can be determined based on the sensor readings obtained while the user is wearing the test article include pressure, ground reaction force, center of pressure, foot contact events, stride time, ground contact time, swing time, rate of pronation, rate of force development, foot strike index, foot orientation, mid-stance, stride length, stride velocity, joint forces, joint moments, or power.

The systems, methods and devices described herein can also include one or more inertial measurement units (IMUs). Each IMU can be associated with a corresponding plurality of force sensors. That is, each IMU can be configured to collect inertial measurement data relating to movement of the same foot under which the force sensors are positioned.

IMU data from the one or more IMUs can be used to determine values of the biomechanical contributing factors for the user. For example, the biomechanical data such as foot contact events, stride time, ground contact time, swing time, rate of pronation, rate of force development, foot strike index, foot orientation, mid-stance, stride length, and stride velocity may be determined wholly or partially using IMU data.

The systems, methods and devices described herein can also be used to acquire sensor data for both of an individual's feet at the same time. In some cases, this may require a separate plurality of force sensors for each foot (e.g. where the force sensors are incorporated into a wearable device).

Where an IMU is included in the system and method, a separate IMU can be provided for each foot. This allows the IMU to collect inertial measurement data relating to movement of that foot. The inertial measurement data specific to the foot can then be used to determine inputs to the machine learning model for that foot.

Each customization criterion can have an associated set of preferred values for the biomechanical contributing factors. The preferred values for the biomechanical contributing factors can be different for different customization criteria. Optionally, preferred values of the biomechanical contributing factors can be determined based on an analysis of a machine learning model trained using biomechanical data from a plurality of training users.

Optionally, the biomechanical contributing factors may be specific to the at least one customization criterion. For instance, a subset of biomechanical contributing factors that impact the at least one customization criterion can be identified as being specific to the corresponding at least one customization criterion.

Alternatively or in addition, the biomechanical contributing factors may be weighed using corresponding factor weights. The factor weights can be determined based on a relative level of contribution for the corresponding factor. Optionally, the factor weights can be determined as criterion-specific weights that are specific to the at least one customization criterion.

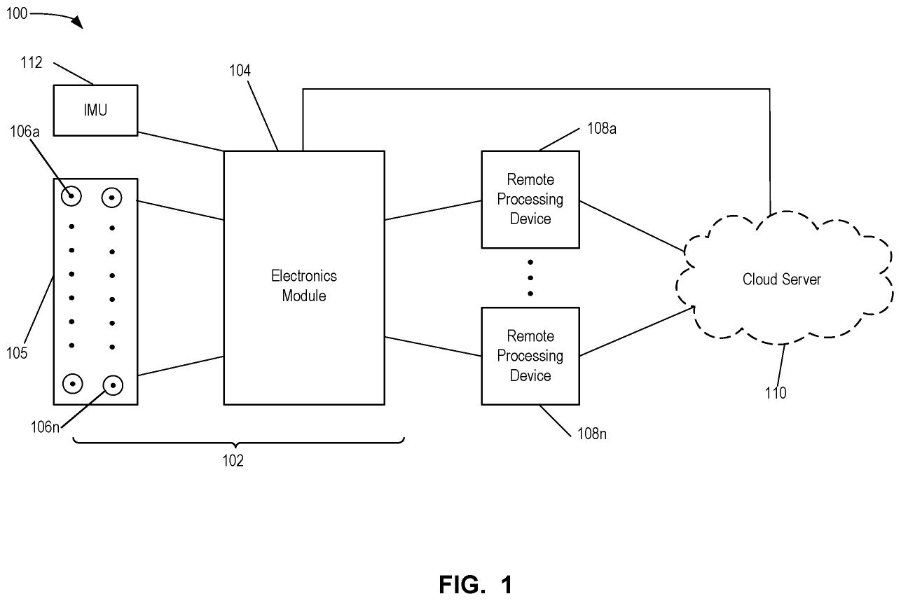

Referring now to FIG. 1, shown therein is a block diagram illustrating an example system 100 that can be used to create a custom footwear article design. The footwear article can generally include any type of footwear article (e.g. footwear and footwear accessories) such as daily-living footwear articles (e.g. sneakers, boots, high heels, socks etc.), athletic footwear articles (e.g. cleats, skates, ski boots, pointe shoes etc.), structural medical devices (e.g. casts, braces, compression socks etc.), and footwear inserts (e.g. insoles, orthotics etc.).

System 100 includes a plurality of sensors positionable underfoot of an individual performing an activity or other type of movement. The sensors may be provided using a wearable device that can be worn while the user is also wearing the test article.

System 100 includes an input unit 102 (also referred to herein as an input device), one or more processing devices 108 (also referred to herein as a receiving device or an output device) and an optional remote cloud server 110. As will be described in further detail below, the input unit 102 may for example be combined with, or integrated into, a carrier unit such as a wearable device or a piece of fitness equipment.

Input unit 102 generally includes a sensing unit 105. The sensing unit 105 can include a plurality of sensors 106a-106n. The plurality of sensors 106a-106n can be configured to collect force sensor data from underneath the foot of an individual.

In the example shown, input unit 102 further includes an inertial measurement unit (IMU) 112. IMU 112 can include one or more sensors for measuring the position and/or motion of the wearable device. For example, IMU 112 may include sensors such as one or more of a gyroscope, accelerometer (e.g., a three-axis accelerometer), magnetometer, orientation sensor (for measuring orientation and/or changes in orientation), angular velocity sensor, and inclination sensor.

The IMU 112 can also be positioned underneath a foot of an individual. However, the IMU 112 need not be positioned underfoot so long as the IMU 112 can collect inertial measurement data relating to the position and/or motion of the foot.

The carrier unit can be configured to position the sensors 106 in contact with (or in close proximity to) an individual's body to allow the sensors 106 to measure an aspect of the activity being performed by the individual. The plurality of sensors 106a-106n may be configured to measure a particular sensed variable at a location of an individual's body when the carrier unit is engaged with the individual's body (e.g. when the individual is wearing a wearable device containing the sensors 106 or when the individual is using fitness equipment containing the sensors 106). In system 100, the plurality of sensors 106a-106n can be arranged to measure force underneath the foot (underfoot) of an individual. As noted above, the IMU 112 can be arranged to measure data relating to the position and/or motion of the individual's foot.

In some examples, the carrier unit may include one or more wearable devices. The wearable devices can be manufactured of various materials such as fabric, cloth, polymer, or foam materials suitable for being worn close to, or in contact with, a user's skin. All or a portion of the wearable device may be made of breathable materials to increase comfort while a user is performing an activity.

In some examples, the wearable device may be formed into a garment or form of apparel such as a sock, a shoe, or an insole. Some wearable devices such as socks may be in direct contact with a user's skin. Some wearable devices, such as shoes, may not be in direct contact with a user's skin but still positioned within sufficient proximity to a user's body to allow the sensors to acquire the desired readings.

In some cases, the wearable device may be a compression-tit garment. The compression-fit garment may be manufactured from a material that is compressive. A compression-fit garment may minimize the impact from “motion artifacts” by reducing the relative movement of the wearable device with respect to a target location on the individual's body. In some cases, the wearable device may also include anti-slip components on the skin-facing surface. For example, a silicone grip may be provided on the skin-facing surface of the wearable device to further reduce the potential for motion artifacts.

The wearable device can be worn on a foot. For example, the wearable device may be a shoe, a sock, or an insole, or a portion of a shoe, a sock, or an insole. The wearable device may include a deformable material, such as foam. This may be particularly useful where the wearable device is a shoe or insole.

The plurality of sensors 106a-106n can be positioned to acquire sensor readings from specified locations on an individual's body (via the arrangement of the sensors on the carrier unit). The sensors 106 can be integrated into the material of the carrier unit (e.g. integrated into a wearable device or fitness equipment). Alternatively, the sensors 106 can be affixed or attached to the carrier unit, e.g. printed, glued, laminated or ironed onto a surface, or between layers, of a wearable device or fitness equipment.

In some examples, the carrier unit may include fitness equipment. The fitness equipment may include various types of fitness equipment on which a user can exert force with their foot while performing an activity. For example, the carrier unit may be fitness equipment such as an exercise mat or a treadmill (e.g. a force-instrumented treadmill).

For clarity, the below description relates to a carrier unit in the form of an insole. The insole carrier unit may be provided in various forms, such as an insert for footwear, or integrated into a shoe. However, other carrier units may be implemented using the systems and methods described herein, such as the wearable devices and fitness equipment described above. Incorporating the sensing unit 105 (and optionally the IMU 112) into a carrier unit in the form of a wearable device may be desirable as it allows the performance of a footwear article to be assessed at various locations and without requiring specifically configured fitness equipment. This allows the footwear article to be evaluated for an individual performing specified activities that generally occur outside of a laboratory environment, such as specific sporting activities (e.g. soccer, football, hockey, cross-country running etc.), occupational activities, or more general daily living activities for example. Accordingly, the performance of the footwear article can be evaluated based on the same conditions in which the article would be used by the individual to perform the specified activity. Furthermore, the collection of the biomechanical data in a “field” setting (i.e. outside of a specified laboratory setting) allows a user to perform the specified activity as they ordinarily would, without needing specific foot scan/gait analysis tests.

Integrating the plurality of sensors into a wearable device also allows biomechanical data to be collected after a custom footwear article has been identified for a user. This allows the use of the custom footwear article to be evaluated to determine whether the custom footwear article provides the desired effect for the relevant customization criteria.

In addition, the biomechanical data can be used to identify changes in the biomechanical contributing factor values while a user is using the custom footwear article. The changes can be identified to the user as an indication that their technique has changed, that the article is potentially beginning to degrade, or that an alternative footwear article design may be preferable for example.

The below description relates to an insole in which the plurality of sensors 106 are force sensors. Various types of force sensors may be used, such as force sensing resistors (also referred to as sensing elements), pressure sensors, piezoelectric tactile sensors, elasto-resistive sensors, capacitive sensors or more generally any type of force sensor that can be integrated into a wearable device or fitness equipment capable of collecting force data underfoot.

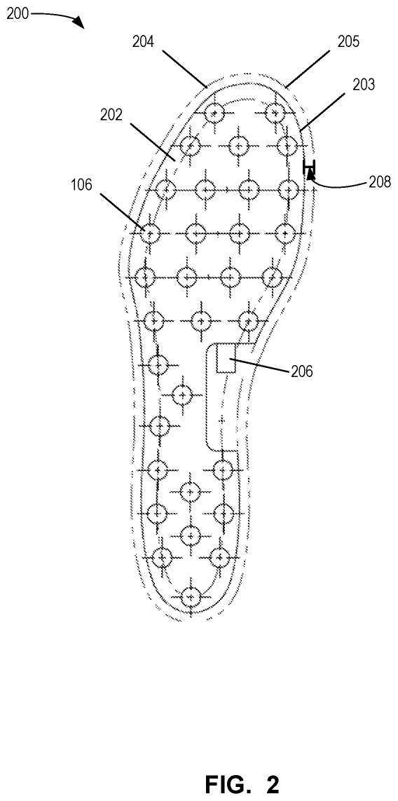

The plurality of sensors 106 may be arranged into a sensor array. As used herein, the term sensor array refers to a series of sensors arranged in a defined grid. The plurality of sensors 106 can be arranged in various types of sensor arrays. For example, the plurality of sensors 106 can be provided as a set of discrete sensors (see e.g. FIG. 2). A discrete sensor is an individual sensor that acquires a sensor reading at a single location. A set of discrete sensors generally refers to multiple discrete sensors that are arranged in a spaced apart relationship in a sensing unit.

Sensors 106a-106n may be arranged in a sparse array of discrete sensors that includes void locations where no sensors 106 are located. Alternatively, sensors 106a-106n may be arranged in a continuous or dense sensor array in which sensors 106 are arranged in a continuous, or substantially continuous manner, across the grid.

Discrete sensors can provide an inexpensive alternative to dense sensor arrays for many applications. However, because no sensors are positioned in the interstitial locations between the discrete sensors and the void locations external to the set of discrete sensors, no actual sensors readings can be acquired for these locations. Accordingly, depending on the desired resolution for the force sensor data, sensor readings may be estimated (rather than measured) at the interstitial locations and at the void locations external to the set of discrete sensors in order to provide sensor data with similar resolution to a dense sensor array. Alternatively, where lower resolution force sensor data is sufficient, sensor readings may not necessarily be estimated.

Various interpolation and extrapolation techniques may be used to estimate sensor values at interstitial locations and external void locations. In some cases, sensor values may be estimated using the methods for synthesizing sensor data described in Applicant's co-pending patent application Ser. No. 17/988,468 filed on Nov. 16, 2022 entitled “SYSTEM AND METHOD FOR SYNTHESIZING SENSOR READINGS”, the entirety of which is incorporated herein by reference. In some cases, sensor values may be estimated using the methods for synthesizing sensor data described in Applicant's co-pending patent application Ser. No. 18/183,642 filed on Mar. 14, 2023 entitled “SYSTEM AND METHOD FOR DETERMINING USER-SPECIFIC ESTIMATION WEIGHTS FOR SYNTHESIZING SENSOR READINGS”, the entirety of which is incorporated herein by reference.

System 100 can be configured to implement methods of creating a custom footwear article design and/or optimizing a footwear article design. The methods of creating a custom footwear article design and/or optimizing a footwear article design can be implemented using a controller of the input device 102, a remote processing device 108, or cloud server 110.

As shown in FIG. 1, input unit 102 includes an electronics module 104 coupled to the plurality of sensors 106 and to optional IMU 112. In some cases, the electronics module 104 can include a power supply; a controller, a memory, a signal acquisition unit operatively coupled to the controller and to the plurality of sensors 106 (and to IMU 112), and a wireless communication module operatively coupled to the controller.

Generally, the sensing unit refers to the plurality of sensors 106 and the signal acquisition unit. The signal acquisition unit may provide initial analog processing of signals acquired using the sensors 106, such as amplification. The signal acquisition unit may also include an analog-to-digital converter to convert the acquired signals from the continuous time domain to a discrete time domain. The analog-to-digital converter may then provide the digitized data to the controller for further analysis or for communication to a remote processing device 108 or remote cloud server 110 for further analysis.

Optionally, the electronics module 104 may include a controller or other processing device configured to perform the signal processing and analysis. In such cases, the controller on the electronics module may be configured to process the received sensor readings in order to determine synthesized sensor readings. In some cases, the controller may be coupled to the communication module (and thereby the sensing unit) using a wired connection such as Universal Serial Bus (USB) or other port.

The electronics module 104 can be communicatively coupled to one or more remote processing devices 108a-108n, e.g. using a wireless communication module (e.g., Bluetooth, Bluetooth Low-Energy, WiFi, ANT+IEEE 802.11, etc.). The remote processing devices 108 can be any type of processing device such as (but not limited to) a personal computer, a tablet, and a mobile device such as a smartphone, a smartwatch or a wristband. The electronics modules 104 can also be communicatively coupled to remote cloud server 110 over, for example, a wide area network such as the Internet.

Each remote processing device 108 and optional remote cloud server 110 typically includes a processing unit, an output device (such as a display, speaker, and/or tactile feedback device), a user interface, an interface unit for communicating with other devices, Input/Output (I/O) hardware, a wireless unit (e.g. a radio that communicates using CDMA, GSM, GPRS or Bluetooth protocol according to standards such as IEEE 802.11a, 802.11b, 802.11g, or 802.11n), a power unit, and a memory unit. The memory unit can include RAM, ROM, one or more hard drives, one or more flash drives or some other suitable data storage elements such as disk drives, etc.

The processing unit controls the operation of the remote processing device 108 or the remote cloud server 110 and can be any suitable processor, controller or digital signal processor that can provide sufficient processing power depending on the desired configuration, purposes and requirements of the system 100.

The display can be any suitable display that provides visual information. For instance, the display can be a cathode ray tube, or a flat-screen monitor and the like if the remote processing device 108 or remote cloud server 110 is a desktop computer. In other cases, the display can be a display suitable for a laptop, tablet or handheld device, such as an LCD-based display and the like.

System 100 can generally be used for creating a custom footwear article design based on sensor readings received from a plurality of sensors worn while a user is wearing a footwear article. In some cases, system 100 may also track additional data derived from the sensor readings. The sensor readings, biomechanical contributing factor values, and derived data may be monitored, stored, and analyzed for the user. Aspects of the monitoring, storage and analysis of biomechanical data and other metrics may be performed by one or more of the input unit 102, and/or a remote processing device 108, and/or the cloud server 110. For example, a non-transitory storage memory of one or more of the input unit 102, and/or a remote processing device 108, and/or the cloud server 110 can store a plurality of preferred biomechanical contributing factor values that can be used to assess and optimize the design of a footwear article.

A remote cloud server 110 may provide additional processing resources not available on the input unit 102 or the remote processing device 108. For example, some aspects of processing the sensor readings acquired by the sensors 106 may be delegated to the cloud server 110 to conserve power resources on the input unit 102 or remote processing device 108. In some cases, the cloud server 110, input unit 102 and remote processing device 108 may communicate in real-time to provide timely feedback to a user regarding the sensor readings, biomechanical contributing factor values, and other related data.

In the example system 100 illustrated in FIG. 1, a single input unit 102 is shown. However, system 100 may include multiple input units 102 associated with the same individual. For example, system 100 may include two separate input units 102, each input unit 102 associated with one of the individual's legs. Sensor data from an individual input unit 102 may be used to determine the expected performance for the test article worn on an individual's corresponding leg.

In some examples, system 100 may include a separate sensing unit 105 (and optionally a separate IMU 112) for each foot of an individual. This may allow the expected performance to be determined separately for a test article worn on each of the individual's feet.

Alternatively, a single sensing unit 105 may be used to acquire force sensor data for both feet of an individual. This may be the case where the sensing unit 105 is incorporated into fitness equipment such as an exercise mat or treadmill. In such cases, the force sensor data acquired by the sensing unit 105 may be associated with individual feet through further processing by electronics module 104 and/or processing device 108.

The IMU 112 can be associated with a single foot. Accordingly, separate IMUs 112 may be provided for both feet. IMU data acquired by the IMU 112 associated with each foot may be used to associate the force sensor data acquired by a single sensing unit 105 with the corresponding foot.

Referring now to FIG. 2, shown therein is an example of an insole 200 that includes a sensing unit 202. The insole 200 is an example of an input device 102 that may be used in the system 100 shown in FIG. 1. The insole 200 may be the footwear insert described in International Patent Application Publication No. WO 2021/092676 A1 (Everett et al.), the entirety of which is incorporated herein by reference.

The insole 200 includes a sensor unit 202 and an optional liner 204. The liner 204 can provide a protective surface between the sensor unit 202 and an individual's foot. The liner 204 may have a slightly larger profile as compared to the sensor unit 202. That is, the outer perimeter 203 of the sensor unit 202 may be inwardly spaced from the outer perimeter 205 of the liner 204 by an offset 208. The offset 208 may be substantially consistent throughout the perimeter of the sensor unit 202 such that the sensor unit 202 is completely covered by the liner 204.

Optionally, the sensor unit 202 can include an IMU (not shown). The sensor unit 202 can also include a connector 206. The connector 206 may provide a coupling interface between the plurality of sensors 106 (and the optional inertial measurement unit) and an electronics module (not shown) such as electronics module 104. The coupling interface can allow signals from the sensors 106 and/or IMU to be transmitted to the electronics module. In some cases, the coupling interface may also provide control or sampling signals from the electronics module to the sensors 106 and/or IMU.

The arrangement of sensors 106 in the sensor unit 202 is an example of a sparse sensor array that may be used to collect force sensor data. In alternative examples, various different types of force sensors, force sensor arrays, and arrangements of force sensors may be used. For example, sensor units containing a dense force sensor array (e.g. a Pedar® insole or Tekscan® system) may also be used.

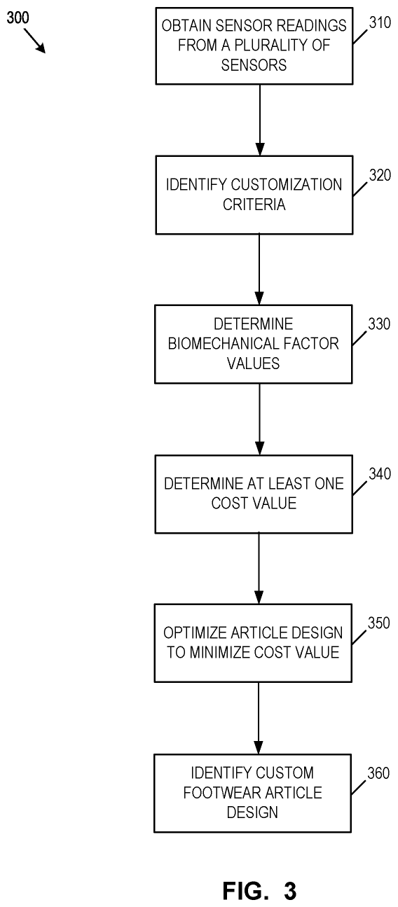

Referring now to FIG. 3, shown therein is an example method 300 for creating a custom footwear article design using force sensor data from a plurality of force sensors positioned underfoot. The method 300 may be used with a plurality of sensors configured to measure human movement or human activity, such as sensors 106 and IMU 112.

Method 300 may be used to determine a custom footwear article design that can be used to manufacture a custom footwear article for a particular user. Alternatively or in addition, method 300 may be used to identify a preferred existing footwear article that has an existing design closely correlated to the custom footwear article design.

At 310, a plurality of sensor readings can be obtained from a corresponding plurality of sensors. At least some of the sensors can be positioned underfoot (i.e. underneath the foot) of a user performing a physical activity or movement. For example, the sensors can include a plurality of force-sensing elements (force sensors) positioned underfoot. The force sensors can be configured to acquire force sensor data at locations underneath an individual's foot.

The force sensors can be positioned at specified locations on a carrier unit such as a wearable device or a piece of fitness equipment. The force sensors can be configured to measure force data relating to human activity. As shown in FIG. 2, the plurality of sensors may be force sensors provided at various locations of an insole. The force sensors can measure force applied to the insole while an individual performs various activities.

The plurality of sensors can also include one or more IMUs. Accordingly, the plurality of sensor readings acquired at 310 can include IMU sensor data received from the one or more IMUs.

Each inertial measurement unit (IMU) can be associated with the plurality of force sensors. For example, the IMU may be incorporated into the same wearable device as the plurality of force sensors. More generally, the IMU can be configured to collect IMU sensor data about a single foot of an individual. This IMU sensor data can be acquired for the same foot for which the sensor readings were obtained from the plurality of force sensors.

The sensor readings acquired at 310 may be acquired as a time-continuous set of sensor readings. This may provide a time-continuous set of sensor data that can be used to synthesize biomechanical data on a time-continuous basis (e.g. determining time-continuous power) and/or individual data values (e.g. an average power per stride, a max power per stride). Depending on the nature of the sensors and the signal preprocessing performed, the time-continuous sensor data may be discretized, e.g. using an analog to digital conversion process. Even where the sensor data is discretized, the set of sensor data may allow the biomechanical data to be determined as (discretized) time-continuous values or average values.

Various different types of biomechanical data may be synthesized from the sensor readings acquired at 310. The biomechanical data can be associated with the user and the footwear article being worn by the individual while the sensor readings were collected.

The biomechanical data can be defined in various ways. For example, where the sensor readings acquired at 310 provide time-continuous sensor data, the biomechanical data can be defined to include time-continuous values. The time-continuous biomechanical data values may provide more granular data that can be used to assess the performance of a test article.

Examples of biomechanical data that can be synthesized from the sensor readings include one or more of a pressure, a ground reaction force, a center of pressure, a foot contact event, a stride time, a ground contact time, a swing time, a rate of pronation value, a rate of force development, a foot strike index, a foot orientation, a mid-stance, a stride length, a stride velocity, a joint force, a joint moment, or a power for example. Depending on the type of biomechanical data being synthesized, the sensor data may be separated into a plurality of strides. This may be particularly relevant for biomechanical data relating to running or walking movements.

The motion that an individual goes through while running or walking is typically referred to as a gait cycle. The gait cycle generally refers to the time period between the time when an individual's foot contacts the ground and the subsequent time when the same foot contacts the ground again. In some cases, the term gait cycle may also refer to the events that occur over that time period.

The term ‘stride’ is often used to refer to a single gait cycle for one foot. A stride can be divided into two phases: a stance phase and a swing phase. The stance phase generally refers to the period when the individual's foot remains, at least partially, in contact with a surface such as the ground. The swing phase generally refers to the period when the individual's foot is not in contact with the surface (e.g. as the foot swings in the air between periods when the foot is in contact with the ground).

The plurality of strides can be identified using data from the sensor readings. Each stride may be identified based on times when the individual's foot first contacts the ground (a foot-contact time) and/or times when the individual's foot leaves the ground (a foot-off time).

Each stride can be defined to correspond to a stride period. The stride period generally refers to the time period over which a single gait cycle extends. The endpoints of the stride period may vary in different implementations of method 300. For example, the stride period can be defined as the length of time between adjacent foot-contact times. Alternatively, the stride period can be defined as the length of time between adjacent foot-off times. The biomechanical data values may be determined for each stride based on the sensor readings acquired at 310 relating to the corresponding stride period. The biomechanical data values for a given stride may be determined as time-continuous stride values and/or overall stride values (e.g. mean values and/or peak values). Alternatively or in addition, biomechanical data values may be determined for multiple strides (e.g. mean values and/or peak values across multiple stride periods).

Force values and force-derived values may be determined based on aggregate force data for a corresponding stride or strides. The sensor readings may include corresponding force sensor values from each of the force sensors in the plurality of force sensors. The sensor readings may include a plurality of corresponding force sensor values from each of the force sensors in the plurality of force sensors at various time points throughout the time period of the stride or strides (e.g. as time-continuous sensor readings or sensor readings at discrete time steps). The aggregate force data may be determined based on the sensor values received from multiple force sensors in the plurality of force sensors over the time period of the stride or strides.

Various different methods can be applied to synthesize the biomechanical data values based on the sensor readings acquired at 310. Example methods for determining parameters such as stride time, stride length, stride velocity, ground reaction forces, foot contact events, and so forth are described in further detail in Applicant's co-pending patent application Ser. No. 17/991,501 entitled “SYSTEM AND METHOD FOR ANALYZING FORCE SENSOR DATA” filed Nov. 21, 2022, the entirety of which is incorporated herein by reference.

Example methods for determining running power are described in further detail in Applicant's co-pending patent application Ser. No. 17/990,598 entitled “SYSTEM AND METHOD FOR DETERMINING RUNNING POWER” filed Nov. 18, 2022, the entirety of which is incorporated herein by reference.

Example methods for determining cycling power are described in further detail in Applicant's co-pending patent application Ser. No. 17/989,914 entitled “SYSTEM AND METHOD FOR DETERMINING CYCLING POWER” filed Nov. 18, 2022, the entirety of which is incorporated herein by reference.

Optionally, the sensor readings (and corresponding biomechanical data) can be associated with a specified activity. That is, the sensor readings can be obtained while the individual is performing one or more activities or movements associated with the specified activity. The design of the footwear article can then be assessed and optimized for the specified activity.

The sensor readings may be obtained while an individual is wearing a test footwear article while also wearing one or more wearable devices that includes a plurality of sensors. The test footwear article may be a specified article type associated with a specified activity. The wearable device containing the plurality of sensors may be configured to interface with the specified article type.

For instance, where the footwear article is being customized for a skiing activity, the test footwear article can be ski boots. In such cases, a wearable device in the form of an insole may be inserted into the user's ski boots to obtain sensor readings while the user performs skiing activities for example.

Optionally, the design of a test footwear article may be assessed for a plurality of specified activities and/or for general use. This may allow the design of the footwear article to be optimized for an individual performing different activities, e.g. to identify a footwear article design that satisfies at least one customization criterion across multiple activities.

Sensor data collection can be initiated by the user directly or by a third-party overseeing data collection. For example, the sensor readings can be obtained in response to a user initiating a sensor collection session, e.g. through a mobile application on their mobile device. A user can initiate a data collection session while wearing the wearable device along with a test footwear article. The user may input test article identification data to the mobile application sufficient to identify the test footwear article. Sensor data can then be collected from the sensors in the wearable device while the user performs one or more activities.

Optionally, the user may specify a particular activity set they are performing (e.g. soccer) so that the sensor readings are associated with that specified activity set. Alternatively or in addition, an activity classification process may be applied to identify the specified activity set being performed.

Sensor data can be collected for the same user across multiple sensor data collection periods, including periods relating to different test articles or activities. The sensor data from the various collection periods can be stored for later analysis.

At 320, at least one customization criterion can be determined. The at least one customization criterion can be defined to reflect the reason or purpose for which the footwear article design is being customized.

Typically, the at least one customization criterion can include a customization metric. Optionally, a customization activity can be specified for the at least one customization criterion.

Optionally, the at least one customization criterion can include both a specified customization activity and a specified customization metric. The design of the footwear article can then be customized to improve the specified customization metric for the user when the user is performing the specified customization activity.

A customization activity can be defined as a particular activity for which the user intends to use the footwear article. The particular activity may be defined to include a specified activity set. The specified activity set can include specified movements or actions relating to performing a specified activity. Various different types of activities may be specified, such as specific sporting activities (e.g. soccer, football, hockey, cross-country running etc.), occupational activities, or more general daily living activities for example.

A customization metric can be defined as an aspect of the user's use of the footwear article for which the design of the footwear article is intended to be optimized. The customization metric can specify one or more aspects of a user's movement experience that the custom footwear article design is intended to improve.

Various different types of specified customization metrics may be used. For example, the specified customization metric can include an injury risk metric. The injury risk metric can be defined to represent a probability and/or severity of injury posed to the individual from wearing the footwear article. The injury risk metric can be defined so that the design of the footwear article can be optimized to reduce the probability and/or severity of injury.

The injury risk metric can be defined as a specific injury risk metric based on the probability and/or severity of a specific injury (e.g. an anterior cruciate ligament (ACL) tear risk metric). Alternatively, the injury risk metric can be defined as a general injury risk metric based on the probability and/or severity of any injury (e.g. a lower-limb injury risk metric).

Alternatively or in addition, the specified customization metric can include a performance level metric. The performance level metric can be defined to represent an expected level of performance for the individual while wearing the footwear article. The performance level metric can be defined so that the design of the footwear article can be optimized to improve the expected level of performance for the user.

Alternatively or in addition, the specified customization metric can include a discomfort level metric. The discomfort level metric can be defined to represent an expected level of discomfort that the individual will experience while wearing the footwear article. The discomfort level metric can be defined so that the design of the footwear article can be optimized to improve the expected comfort level (i.e. to reduce the level of discomfort) for the user.

As noted above, the at least one customization criterion can include both a specified customization activity and a specified customization metric. Accordingly, the customization metric (e.g. injury risk metric, performance level metric, or discomfort level metric) may be evaluated for the individual wearing the footwear for a specified activity.

Optionally, the customization metric may be defined (at least in part) based on the corresponding customization activity. For example, a performance level metric can be defined according to a specific goal for the corresponding customization activity. The goal may be evaluated based on the individual's performance during a competition involving the customization activity (e.g. performance during a soccer tournament or game). Alternately, the goal may be evaluated based on the individual's performance during training relating to the customization activity (e.g. strength training and conditioning in the off-season).

Alternatively, the customization metric may be defined (at least in part) based on a user's role within the corresponding customization activity. For example, a performance level metric can be defined according to a specific position of the user for the corresponding customization activity (e.g. a goalie, defender, midfielder, or forward in a soccer team).

The at least one customization criterion can be specified by the user. For instance, a user may input the at least one customization criteria through a graphical user interface provided by a computing device such as processing device 108.

At 330 a plurality of biomechanical contributing factor values can be determined based on the sensor readings acquired at 310. Biomechanical contributing factor values can be determined for a plurality of biomechanical contributing factors.

The biomechanical contributing factors can be defined as measurable biomechanical data that contributes (or appears to contribute) to aspects of the use of the footwear article by a user.

The biomechanical contributing factors may be factors identified as being related to the at least one customization criterion identified at 320. An example process that may be used to determine biomechanical contributing factors is described herein below with reference to step 540 of method 500.

Examples of biomechanical data that can define a user's biomechanical contributing factor values can include one or more of a pressure value(s), a ground reaction force value, a center of pressure value, a foot contact event value, a stride time value, a ground contact time value, a swing time value, a rate of pronation value, a rate of force development value, a foot strike index value, a foot orientation value, a mid-stance value, a stride length value, a stride velocity value, a joint force value, a joint moment value, or a power value for example.

The plurality of biomechanical contributing factor values can be determined as user and footwear article-specific values. That is, the biomechanical contributing factor values can be associated with the user and the footwear article worn by the user when the sensor readings were acquired at 310.

The sensor readings obtained at 310 can include sensor data obtained from one or more data collection sessions for a given user. The biomechanical contributing factor values can be determined as the values of the biomechanical data determined from the sensor readings from a single data collection session for a given user.

Alternatively, the biomechanical contributing factor values can be determined based on biomechanical data determined from the sensor readings from a plurality of data collection sessions for a given user. For example, biomechanical data values can be determined for each data collection session based on the corresponding sensor readings. The biomechanical contributing factor values may be determined as average values of the biomechanical data corresponding to the plurality of data collection sessions.

Various different biomechanical contributing factor values may be determined. In some cases, different biomechanical contributing factor values may be determined for different specified activities. For example, a running power value may be determined for activities involving running or walking while a cycling power value may be determined for activities involving cycling.

At 340, at least one cost value can be determined. The at least one cost value can be determined based on at least one difference between the biomechanical contributing factor values determined at 330 and a plurality of preferred biomechanical contributing factor values. For example, the at least one difference can include at least one percent difference between the biomechanical contributing factor values determined at 330 and a plurality of preferred biomechanical contributing factor values.

The preferred values may be identified as the values of the biomechanical contributing factors associated with the at least one customization criterion that are most closely correlated to optimizing the at least one customization criterion. The plurality of preferred biomechanical contributing factor values can be specific to the at least one customization criterion from 320. An example process that may be used to determine preferred biomechanical contributing factor values is described herein below with reference to step 550 of method 500.

The cost value can be defined to represent how far the user's biomechanical contributing factor values (from 330) stray from the preferred values. At least one error value can be determined using a difference between a biomechanical contributing factor value determined at 330 and the preferred biomechanical contributing factor values for the corresponding factor. For example, the error value may be determined using a percent difference between the biomechanical contributing factor value determined at 330 and the preferred biomechanical contributing factor values for the corresponding factor. The cost value can be determined based on the at least one error value. Various different types of cost functions may be used to determine the cost value, such as root-mean square error and mean square error for example.

In some examples, the cost value may be determined as a single-variable cost value that is determined based on the error between a single biomechanical contributing factor value (from 330) and the corresponding preferred biomechanical contributing factor value. For example, a single-variable cost value may be determined based on a single error value determined as a percent difference between the biomechanical contributing factor value determined at 330 and the preferred biomechanical contributing factor value by:

$$error = \frac{\vert prefvalue - uservalue \vert}{prefvalue} * 100 \%$$

where prefvalue represents the preferred biomechanical contributing factor value and uservalue represents the biomechanical contributing factor value (e.g. from 330). Alternatively, the error value can be determined based on an absolute difference between the biomechanical contributing factor value determined at 330 and the preferred biomechanical contributing factor value.

If the cost value is determined using a single-variable error, optimizing the design of the footwear article can improve the corresponding biomechanical contributing factor value for the user. However, optimizing a single-variable cost value may occur at the expense of other biomechanical contributing factors.

Alternatively, the cost value can be determined as a multi-variable cost value that is determined based on a plurality of error values. Each error value can be determined using the difference between a biomechanical contributing factor value determined at 330 and the preferred biomechanical contributing factor values for the corresponding factor. For a multi-variable cost value, a percent difference can be used. This may provide, in effect, normalized error values for the different biomechanical factors being considered.

The plurality of error values may include separate factor-specific error values for each of the biomechanical contributing factor values determined at 330. The cost value may then be determined using a combination of the plurality of error values.

Optionally, each biomechanical contributing factor value can be associated with an associated weight. The weight can be defined to represent a level of contribution of that biomechanical contributing factor to the at least one customization criterion from 320. An example process that may be used to determine the weights of biomechanical contributing factors is described herein below with reference to step 540 of method 500.

The cost value may be determined using a combination of the plurality of factor-specific error values while weighing each factor-specific error value according to the associated weight for the corresponding biomechanical contributing factor. This may ensure that the biomechanical contributing factors that have the biggest impact on the at least one customization criterion will be prioritized during optimization of the footwear article design.

As noted above, the cost value can be determined using a weighted combination of error values. The weighted combination can be determined according to:

$$error = W 1 * \frac{\vert prefvalue 1 - uservalue 1 \vert}{prefvalue 1} * 100 \% + W 2 * \frac{\vert prefvalue 2 - uservalue 2 \vert}{prefvalue 2} * 100 \% + … Wn * \frac{\vert prefvaluen - uservaluen \vert}{prefvaluen} * 100 \%$$

where prefvalue1 represents a first preferred biomechanical contributing factor value, uservalue1 represents a first biomechanical contributing factor value (e.g. from 330), and W1 represents a first weight associated with the first biomechanical contributing factor; prefvalue2 represents a second preferred biomechanical contributing factor value, uservalue2 represents a second biomechanical contributing factor value (e.g. from 330), and W2 represents a second weight associated with the second biomechanical contributing factor; prefvaluen represents an nth preferred biomechanical contributing factor value, uservaluen represents an nth biomechanical contributing factor value (e.g. from 330), and wn represents an nth weight associated with an nth biomechanical contributing factor.

At 350, the footwear article design can be optimized by adjusting at least one characteristic of the test footwear article worn by the user. The optimization can be defined to minimize the cost value determined at 340.

The design of the test footwear article can provide, in effect, a base template for the footwear article design. The base template can specify a plurality of design characteristics related to the construction of the footwear article. The optimization process can evaluate how changes in those characteristics may improve the user's experience with the footwear article according to the at least one customization criterion.

Various different characteristics of the test footwear article can be adjusted while optimizing the footwear article design. For example, the at least one characteristic can include at least one of a material hardness, a material density, a material stiffness, a material texture, a footwear shape, footwear contouring, a footwear size, a footwear component number, a footwear component size, a footwear component location, or a toebox volume.

Various different types of optimization algorithms may be used, such as gradient descent optimization, least squares optimization and so forth. The optimization algorithms can include iterative optimization methods in which the at least one characteristic of the test footwear article is adjusted and the resultant error values are evaluated until the cost value is minimized. For example, the design of the footwear article can be optimized iteratively using finite element analysis of a model of the design of the footwear article.

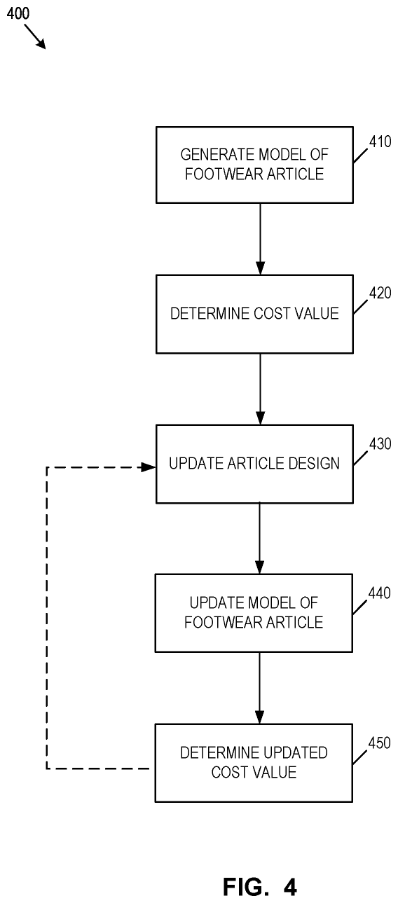

An example process 400 for optimizing a footwear article design is described in further detail below with reference to FIG. 4.

At 360, the custom footwear article design can be identified as the footwear article design (from 350) that corresponds to a minimum cost value. The custom footwear article design can then be used to provide the user with a custom footwear article.

For example, a custom footwear article may be manufactured according to the custom footwear article design. This may ensure that the footwear article is maximally customized to the individual user.

Various different types of manufacturing processes can be used to manufacture the custom footwear article. For instance, the custom footwear article can be manufactured using additive manufacturing (including for instance 3D printing), subtractive manufacturing, casting/molding, fabrication, etc.

Alternatively or in addition, a preferred existing footwear article similar to the custom footwear article can be identified. The preferred existing footwear article can be identified by comparing the characteristics of the custom footwear article design with characteristics of existing footwear articles. The existing footwear articles may also include off-the-shelf footwear articles as well as footwear articles that have been previously customized for other users. The existing footwear article having the most similar characteristics (e.g. that would result in the lowest cost value as determined at step 340) can be identified as the preferred existing footwear article.

An indication of the preferred existing footwear article can then be provided to the user. The indication can include a footwear article recommendation for the user relating to an existing footwear article. This may allow the user to acquire a footwear article that has been identified for the at least one customization criterion without requiring a specially manufactured article. This may allow the user to obtain footwear identified for the user using the at least one customization criterion at lower a cost.

Optionally, the design of a custom footwear article can be updated for a user on a regular basis. For example, additional sensor data may be obtained from a user on an ongoing basis. The additional sensor data can include data obtained while the user is wearing a custom footwear article to perform one or more activities. The design of the custom footwear article can then be updated (e.g. using method 300) based on this additional sensor data. This can provide a user with custom footwear article designs that adapt to changes over time.

The additional sensor data can also be used to further refine the biomechanical contributing factors and preferred biomechanical contributing factor values for the at least one customization criterion.

Alternatively or in addition, the custom footwear article design may be stored, e.g. for later review, comparison, analysis, or monitoring.

Optionally, the custom footwear article design can also include custom aesthetic features (e.g. colors of the footwear article, colors of various features of the footwear article, or aesthetic accessories). The custom aesthetic features may be defined manually by a user through a customization user interface.

Alternatively or in addition, the custom aesthetic features can include automatically generated aesthetic features. The automatically generated aesthetic features may be defined based on the sensor data obtained from the user. For instance, the automatically generated aesthetic features can include features representing specific levels of performance or achievement by the user. For example, the color of the footwear article may be selected to represent the user's performance (e.g. progressing through a series of colors or aesthetic design patterns as the user's performance improves).

Referring now to FIG. 4, shown therein is an example method 400 of optimizing a footwear article design that may be used with a method of customizing a footwear article such as method 300. The method 400 may be applied to determine an optimized design for a footwear article that is evaluated using a wearable device such as device 200.

At 410, a model of the test footwear article is generated. The test footwear article can be the test footwear article worn by a user while sensor data is obtained from the user.

The model of the test footwear article can be defined based on the characteristics of the test footwear article. The model can be generated in various ways. For example, the model may be generated manually through a user interface of a modelling software program by a user inputting the characteristics of the test footwear article. As another example, a pre-existing model of the test footwear article may be imported into a modelling program (e.g. through an API provided by the manufacturer of the test footwear article. As yet a further example, a model of the test footwear article can be generated from a three-dimensional scan of the test footwear article.

At 420, a cost value associated with the modelled test article can be determined. For example, the cost value may be determined as described herein above at step 340 of method 300. As described herein above, the cost value may be determined using biomechanical contributing factor values determined from sensor data obtained from a user and preferred values of biomechanical contributing factors.

Method 400 can then proceed to an iterative optimization process shown by steps 430-450. The iterative optimization process can be defined to optimize the footwear article design by iteratively adjusting at least one characteristic of the test footwear article in order to minimize the cost value determined at 420.

The iterative optimization process can include finite element analysis (FEA) of the footwear article design. The model can be defined at 410 as a three-dimensional finite element model of the test footwear article. The three-dimensional finite element model can be defined to enable pressure distributions to be determined based on applied loads and the characteristics of the article. The design of the footwear article can be optimized iteratively in steps 430-450 using finite element analysis of the model of the footwear article design.

For example, finite element analysis of the model of the footwear article can be used to determine a pressure distribution map for the footwear article design. The pressure distribution map can specify modelled pressure values at all locations of the footwear article model. The modelled pressure values can represent the pressure values that would be experienced by the user when wearing a footwear article corresponding to the updated article design.

At 430, the article design can be updated by modifying one or more characteristics of the design. In the first iteration of the iterative optimization process, the article design can be updated to adjust at least one feature or characteristic of the test article model generated at 410. The updated article design can be associated with a subsequent test article model. Subsequent iterations may then modify one or more characteristics of a preceding article design (including any of the preceding article designs).

Examples of characteristics and features of a footwear article that may be adjusted include, but are not limited to, a material hardness, a material density, a material stiffness, a material texture, a footwear shape, footwear contouring (e.g. with posting), a footwear size (e.g. length, width, thickness), a footwear component number, a footwear component size, a footwear component location (e.g. a lace location or a collar location), or a toebox volume.

The changes to the characteristics of the footwear article can be limited using specified constraints. The constraints may be user-specific (e.g. the shoe length and width can be limited to length and width values that would be suitable for the user). The constraints can also be more general, relating to material cost factors and other manufacturing constraints. Modifications to the article design can be limited by the constraints for the plurality of characteristics.

At 440, the model of the footwear article can be updated based on the updated article design from 430. The model can be updated to adjust the model characteristics based on the changes in the design characteristics at 430.

An updated pressure distribution map can be determined for the updated model of the footwear article (e.g. through finite element analysis of the updated model). The pressure distribution map can specify modelled pressure values at all locations of the updated footwear article model.

At 450, an updated cost value can be determined based on the updated model from 440. The updated cost value can be determined based on the biomechanical contributing factor values resulting from the updated model of the footwear article design. The updated cost value may change based on changes in the biomechanical contributing factor values resulting from the characteristics changed at 430. For instance, the updated pressure distribution map can be analyzed to determine updated biomechanical contributing factor values for the updated model.

Determining the updated cost value based on an updated model of the footwear article design can allow the design of the footwear article to be customized without requiring the footwear article to be manufactured and tested. This may further facilitate an iterative optimization of the footwear article design by evaluating a plurality of alternative designs computationally.

Method 400 can then return to step 430 to continue updating the article design. Steps 430-450 can repeat iteratively until a minimum cost value is determined. The article design associated with the minimum cost value can be identified as the custom footwear article design (e.g. at 350) that has been optimized for the specified at least one customization criterion.

Table 1 below illustrates a simplified example of optimization parameters that can be used to perform an iterative optimization process such as that described at steps 430-450 of method 400.

TABLE 1
Simplified Example of Optimization Parameters

| Optimization parameter | Example Parameter-Related Variables |
|---|---|
| Cost value: F(x, y, . . .) | Biomechanical contributing factor error |
| | value(s) |
| Load conditions (e.g. | Sensor data, e.g. force sensor data |
| forces applied to | obtained during an activity. |
| the feet) | The load may be static (e.g. standing, |
| | where body weight is applied to the two |
| | insoles) or dynamic (e.g. running, where |
| | the load is cyclic). |
| | The load conditions may include |
| | variables measured from the IMU (e.g. |
| | speed, foot angle, etc.). |
| Footwear characteristics | Inner footwear length = 31 cm |
| and constraints | Inner footwear width = 10 cm |
| x_{lower limit} < x < x_{upper limit} | 0 cm < heel height < 3 cm |
| y > y_{lower limit} | 10 ≤ midsole foam hardness (Shore |
| . | A) ≤ 30 |
| . | 2 cm > upper thickness |
| . | . |
| | . |
| | . |

Table 1 provides a simplified example of parameters and associated variables that can be used to optimize the design of a footwear article. However, it should be understood that different parameters, variables and different combinations of parameters and variables can be used to optimize the footwear article design beyond the examples shown in Table 1.

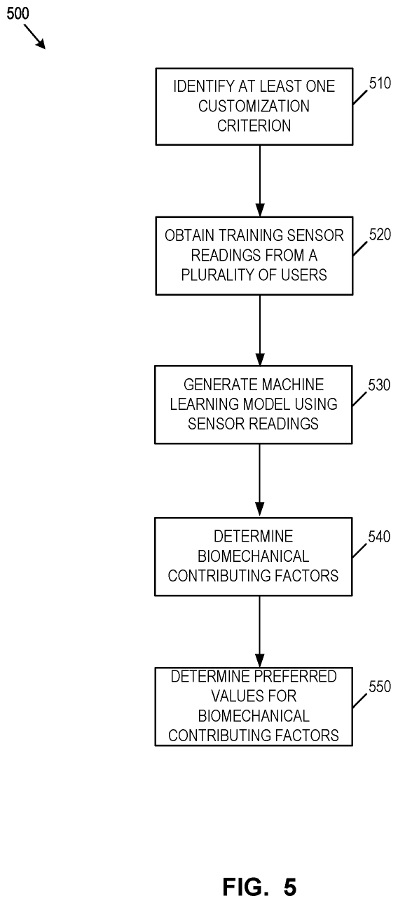

Referring now to FIG. 5, shown therein is example method 500 for determining biomechanical contributing factors that may be used with a method of customizing a footwear article such as method 300 and/or a method of optimizing a footwear article design such as method 400. The method 500 may be applied to determine biomechanical contributing factors and preferred values of biomechanical contributing factors associated with one or more customization criteria. The one or more customization criteria can include at least one customization metric and/or at least one customization activity.

As explained herein above, a user may wish to customize their footwear for a variety of reasons, such as, to improve their athletic performance, to reduce their risk of injury, to improve their comfort, etc. As described herein, these aspects of a user's movement are referred to as customization metrics that can be applied to customize the design of a footwear article.

Alternatively or in addition, a user may wish to customize their footwear for use in a particular activity. As described herein, a customization activity can be defined as a particular activity for which the user intends to use the footwear article.

In order to customize the design of a footwear article for a particular customization criterion, biomechanical contributing factors associated with the customization criterion can be identified. Furthermore, a level of contribution (e.g. a factor weight) of each biomechanical contributing factor associated with the customization criterion can be identified to reflect how much a biomechanical contributing factor can impact the corresponding criterion.

For example, if a user desires to customize a footwear article for an injury risk metric, it is important to identify what aspects of that user's use of the footwear article increases or decreases the risk of injury.

Method 500 describes an example process for identifying biomechanical factors associated with a customization criterion based on an analysis of a machine learning model trained using biomechanical data from a plurality of training users.

At 510 at least one training customization criterion can be identified. The training customization criterion generally corresponds to the customization criterion described herein.

At 520, training sensor readings can be obtained from a plurality of training users. The training sensor readings can be obtained from each training user using a corresponding plurality of sensors. The training sensor readings may be obtained from the training users in generally the same manner as the sensor readings obtained at 310 described herein above.

The training sensor readings at 520 can include sensor data associated with the at least one training customization criterion identified at 510. The plurality of training users can be defined as a criterion-specific group of training users. The criterion-specific group of training users can include training users for whom result data associated with the at least one training customization criterion is known.

For example, a criterion-specific group of training users associated with an injury risk metric criterion can include training users for whom an injury value (e.g. a non-injured class, a pre-injury class, or a post-injury class) is known or can be established at the time of sensor data collection or at a later time. As another example, a criterion-specific group of training users associated with a running activity criterion can include training users from whom sensor data was obtained while performing a running activity.

Each customization metric can be associated with a plurality of metric values. The plurality of metric values can represent a range of results/outcomes corresponding to the customization metric. The plurality of metric values can be defined in various ways, such as a numerical value or a result class or category.

For example, an injury risk metric may be associated with injury risk classes such as a non-injured class, a pre-injury class, or a post-injury class. An athletic performance metric may be associated with performance categories or classes such as poor, moderate, great etc. A comfort metric may be associated with a comfortable class and an uncomfortable class or a range of comfort levels (e.g. 1-10 with 1 representing extreme discomfort and 10 representing extreme comfort).

The plurality of training users can be defined to include users associated with different metric values for a customization metric. The plurality of training users can be defined to include users associated with metric values spanning the range of possible metric values for the customization metric. The sensor readings obtained at 520 can thus include sensor data from users representing the different metric values of the customization metric.

The training sensor readings obtained at 520 can be used to synthesize training biomechanical data. The training biomechanical data can be included in training data used to train the machine learning model.

The training biomechanical data can include different types of data that can be used to define a training user's biomechanical contributing factor values such as one or more of a training pressure, a training ground reaction force, a training center of pressure, a training foot contact event, a training stride time, a training ground contact time, a training swing time, a training rate of pronation, a training rate of force development, a training foot strike index, a training foot orientation, a training mid-stance, a training stride length, a training stride velocity, a training joint force, a training joint moment, or a training power for example.

The training biomechanical data from each set of sensor data obtained from each training user can be associated with, or labelled, to distinguish between training biomechanical data associated with different metric values for one or more customization criteria.

For example, training biomechanical data can be identified as non-injury data (e.g. training biomechanical data from training users not injured), pre-injury data (e.g. training biomechanical data from training users prior to experiencing an injury), or injured data (e.g. training biomechanical data from training users who are injured). Optionally, injured data may be further labelled with a specified injury type or location.

Alternatively or in addition, training biomechanical data can be identified as low-performance data (e.g. training biomechanical data from training users with poor performance in the customization activity), moderate performance data (e.g. training biomechanical data from training users with moderate performance in the customization activity), or high performance data (e.g. training biomechanical data from training users with high performance in the customization activity).

Alternatively or in addition, training biomechanical data can be identified as non-discomfort data (e.g. training biomechanical data from training users not experiencing discomfort), pre-discomfort data (e.g. training biomechanical data from training users prior to experiencing discomfort), or discomfort data (e.g. training biomechanical data from training users experiencing discomfort). Optionally, discomfort data may be further labelled with specified locations of discomfort.

Optionally, training sensor data collected from a training user (and associated training biomechanical data) can be associated with values for multiple different customization metrics (e.g. an injury risk metric value and a comfort metric value). This may allow the sensor data to be used for training multiple machine learning models related to different customization criteria.

Different combinations of input data may be used to train and implement the machine learning model. As explained above, various types of biomechanical data synthesized from the sensor readings acquired at 520 may be used to train the machine learning model.

Optionally, additional input data may be used to train the machine learning model. For instance, non-sensor user data relating to a particular user who is performing an activity may be provided as an input to the machine learning model, such as a user gender, user anthropometric data (e.g. leg length, shoe size etc.), user injury history, rating of perceived exertion and so forth. The non-sensor user data may be input by a user through their processing device or retrieved from storage data, e.g. accessible through a remote processing device.

Optionally, user feedback data relating to the particular user may be provided as an input to the machine learning model. For instance, user feedback data may be collected through a user health and wellbeing survey completed by the user. The user feedback data can include data relating to the user's overall health and wellbeing such as fatigue, nutrition, mental health and so forth. The user feedback data may be collected at various times, e.g. daily, weekly, before an activity, after an activity and so forth.

Optionally, article feedback data relating to a particular footwear article may be provided as an input to the machine learning model. The article feedback data can also include data relating to a user's experience of the footwear article such as a level of comfort or discomfort, locations of discomfort, and so forth.

Optionally, additional sensor data may be acquired from the users while performing the given activity. For instance, the user may perform an activity while wearing additional sensors such as a heartrate monitor, EMG or IMU sensors at locations other than the foot such as the tibia for example. This may allow the machine learning model to be trained to determine a metric value indicative of whether the test article impacts other athletic metrics beyond those directly measured through the foot-related sensor data.

Optionally, the training data can include article-related sensor data. For example, training sensor readings obtained at 520 can be used to determine article-related data such as article traction representing the level of gripping or slipping for the footwear article.

The sensor readings from 520 can also be obtained over an extended period of time. For example, the sensor readings can include multiple training sensor sets from one or more of the training users. This can include training sensor sets from the same training user while that training user is associated with a different metric value for the same customization metric (e.g. sensor data obtained while a user is injured and non-injured).

At 530, the training sensor readings can be used to train a machine learning model corresponding to the at least one customization criterion from 510. The machine learning model can be configured to determine a metric value for a corresponding customization metric (from 510) based on receiving biomechanical data as an input. The machine learning model can be used to identify biomechanical contributing factors and preferred values of the biomechanical contributing factors for the at least one customization criterion from 510.

For example, where the at least one customization criterion includes an injury risk metric, the machine learning model can be defined to predict whether biomechanical data synthesized from the sensor readings indicates that the user is non-injured, pre-injury, or post-injury.

As noted above, the machine learning model can be trained using training data that includes the training biomechanical data determined from the training sensor data received at 520. The training process may vary depending on the type of machine learning model being implemented.

The machine learning model can be trained to predict a metric value for a customization metric in response to receiving biomechanical data from a user. The machine learning model can be trained using the training data generated from each set of sensor data obtained from a given training user along with the metric value associated with that set of sensor data.

For a given customization metric, separate machine learning models can be trained for each customization activity. For example, the location of peak pressure may be a contributing factor to a comfort metric for a running activity, but it may not be a contributing factor (or its contribution may be weighed differently) to the comfort metric for a weightlifting activity. Training separate machine learning models for each activity can ensure that the biomechanical contributing factors (and optional contribution weights) relevant to a particular activity are accurately identified.

Various different types of machine learning models may be used to determine the corresponding metric value of a customization metric. For example, various types of classification models may be used to predict a metric value for a customization criterion.

For example, the machine learning model can be defined to include a probabilistic classifier. The probabilistic classifier can be trained to output the metric value as a probability value indicating a probability of optimal performance or a probability of injury. For instance, the probabilistic classifier can be trained to output an injury risk metric value that indicates a probability of injury in a range between 0% (indicating a high level of confidence that the user is non-injured) and 100% (indicating a high level of confidence that the user is pre-injury/about to get injured).

Alternatively or in addition, the machine learning model can be defined to include a multinomial classifier. The multinomial classifier can be trained to output an injury risk metric value as a confidence value that the user is assigned to a certain category from a group of categories (e.g. a non-injured category, a pre-injury category, a post-injury category etc.).

Various types of classification algorithms may be used to provide the probabilistic classifier and/or multinomial classifier, such as logistic regression algorithms. Alternatively, a different type of machine learning could be used to determine the predicted metric value, such as, for example neural network models (e.g. a recurrent neural network), decision trees, support vector machines, prediction models and so forth.

Recurrent neural network models may be particularly useful for processing biomechanical data synthesized from sensor readings acquired from training users over multiple sessions of performing an activity.

At 540, biomechanical contributing factors associated with the at least one customization criterion (from 510) can be determined. The biomechanical contributing factors can be identified based on an analysis of the machine learning model generated at 530.

The machine learning model can be analyzed to determine a relative level of contribution for each type of biomechanical data to the predicted metric value output by the model. The relative level of contribution can be used to identify which type of biomechanical data featured the most prominently in the model's predictions. Those types of biomechanical data can be identified as the biomechanical contributing factors for the customization metric.

Optionally, principal component analysis can be used to identify types of biomechanical data that are irrelevant or overlap with other types of biomechanical data. These irrelevant or overlapping types of biomechanical data can be omitted from the biomechanical contributing factors for the customization metric. This may help reduce the computation time involved in calculating the cost value and optimizing the footwear article design at 340 and 350.

Optionally, the relative level of contribution for each biomechanical contributing factor can be used to determine a factor weight for the respective biomechanical contributing factor.

The factor weight for a given biomechanical data type can be determined in various ways. For example, the entire set of biomechanical data types can be provided as inputs to a machine learning model trained to predict the metric value. The machine learning model and the predicted metric value can then be analyzed (e.g. using interpretability methods) to identify a relative level of contribution/influence for each biomechanical data type. The relative level of influence for each biomechanical data type can be identified as the level of impact/contribution that biomechanical data type has on the predicted metric value relative to the other biomechanical data types. The factor weight for each biomechanical data type can then be defined based on the level of impact identified for that biomechanical data type. For instance, a biomechanical data type that has a large impact on the predicted metric value would have a larger weight (e.g. W₁=0.7) and a biomechanical data type with a relatively lesser impact on the prediction would have a smaller weight (e.g. W₂=0.05).

Alternatively, a machine learning model such as boosted classifier can be used to identify the factor weights for the plurality of biomechanical data types. The boosted classifier can be defined with a plurality of weak learner models. Each biomechanical data type can be provided as an input to a weak learner model (e.g. a decision tree). The boosted classifier can be trained using an adaptive boosting process (e.g. AdaBoost). The factor weights for each of the biomechanical data types can be determined based on the weights that results from training of the boosted classifier.

Preferred values of the biomechanical contributing factors can then be identified at 550. The preferred values of the biomechanical contributing factors can be identified as the values of the respective biomechanical contributing factors that contribute to, or are associated with, a desirable metric value. If a range of values is associated with a desirable metric value, the preferred value of the biomechanical contributing factor can be calculated as a mean or median of the values in the range.

Alternatively, preferred biomechanical contributing factor values may be identified based on historical values known to correlate to a desired metric value.

As described herein above, biomechanical contributing factors can be identified as being associated with one or more customization criteria. Aspects of the biomechanical contributing factors, preferred values and weights may be identified through an analysis of sensor data obtained from a plurality of training users. Once identified, the biomechanical contributing factors, preferred values and weights can be stored in non-transitory storage memory on a processing device 108, cloud server 110 and/or other non-transitory storage memory device.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method for creating a custom footwear article design, the method comprising:
obtaining a plurality of sensor readings from a corresponding plurality of sensors provided in a wearable device, and while the wearable device is worn by a user while also wearing a test footwear article;
identifying at least one customization criterion for the user;
determining a plurality of biomechanical contributing factor values for the user based on the sensor readings;
determining a cost value based on at least one difference between the plurality of biomechanical contributing factor values and a plurality of preferred biomechanical contributing factor values;
optimizing a footwear article design by adjusting at least one characteristic of the test footwear article to minimize the cost value; and
identifying the custom footwear article design as the footwear article design corresponding to a minimum cost value.

2. The method of claim 1, further comprising manufacturing the custom footwear article using the custom footwear article design.

3. The method of claim 1, further comprising:
identifying a preferred existing footwear article similar to the custom footwear article; and
outputting an indication of the preferred existing footwear article.

4. The method of claim 1, wherein
each biomechanical contributing factor value has an associated weight representing a level of contribution of a corresponding biomechanical contributing factor to the at least one customization criterion;
each difference of the at least one difference is used to determine a factor-specific error value; and
the cost value is determined by weighing each factor-specific error value according to the associated weight for the corresponding biomechanical contributing factor.

5. The method of claim 1, wherein the design of the footwear article is optimized iteratively using finite element analysis of a model of the design of the footwear article.

6. The method of claim 1, wherein the plurality of sensors comprises one or more of a force-sensing element and an inertial measurement unit.

7. The method of claim 1, wherein the biomechanical contributing factor values comprise at least one of: a pressure value, a ground reaction force value, a center of pressure value, a foot contact event value, a stride time value, a ground contact time value, a swing time value, a rate of pronation value, a rate of force development value, a foot strike index value, a foot orientation value, a mid-stance value, a stride length value, a stride velocity value, a joint force value, a joint moment value, or a power value.

8. The method of claim 1, wherein the at least one characteristic comprises at least one of a material hardness, a material density, a material stiffness, a material texture, a footwear shape, footwear contouring, a footwear size, a footwear component number, a footwear component size, a footwear component location, or a toebox volume.

9. The method of claim 1, wherein the at least one customization criterion comprises a specified customization metric, and the specified customization metric is one of an injury risk metric, a performance level metric, and a discomfort level metric.

10. The method of claim 9, wherein
the plurality of preferred biomechanical contributing factor values are defined based on an analysis of a machine learning model trained to determine a value of the specified customization metric, wherein the analysis of the machine learning model identifies the preferred biomechanical contributing factor values as those biomechanical contributing factor values that contribute to a desired metric value of the specified customization metric;
the machine learning model is trained using training data that includes training sensor readings obtained from a plurality of training users performing one or more specified activities, wherein the plurality of users are associated with different metric values of the specified customization metric; and
the training data comprises training user anthropometric data and training user wellness data for the plurality of training users.

11. A system for creating a custom footwear article design comprising:
a plurality of sensors mountable to a user, wherein the plurality of sensors is configured to obtain a plurality of sensor readings from the user while the user is also wearing a test footwear article;
a memory configured to store the plurality of sensor readings and a plurality of preferred biomechanical contributing factor values; and
one or more processors configured to:
identify at least one customization criterion for the user;
determine a plurality of biomechanical contributing factor values for the user based on the sensor readings;
determine a cost value based on at least one difference between the plurality of biomechanical contributing factor values and the plurality of preferred biomechanical contributing factor values;
optimize a footwear article design by adjusting at least one characteristic of the test footwear article to minimize the cost value; and
identify the custom footwear article design as the footwear article design corresponding to a minimum cost value.

12. The system of claim 11, wherein the one or more processors is configured to:
identify a preferred existing footwear article similar to the custom footwear article; and
output an indication of the preferred existing footwear article.

13. The system of claim 11, wherein the one or more processors is configured to:
associate each biomechanical contributing factor value with an associated weight representing a level of contribution of a corresponding biomechanical contributing factor to the at least one customization criterion;
use each difference of the at least one difference to determine a factor-specific error value; and
determine the cost value by weighing each factor-specific error value according to the associated weight for the corresponding biomechanical contributing factor.

14. The system of claim 11, wherein the one or more processors is configured to optimize the design of the footwear article iteratively using finite element analysis of a model of the design of the footwear article.

15. The system of claim 11, wherein the plurality of sensors comprises one or more of a force-sensing element and an inertial measurement unit.

16. The system of claim 11, wherein the biomechanical contributing factor values comprise at least one of: a pressure value, a ground reaction force value, a center of pressure value, a foot contact event value, a stride time value, a ground contact time value, a swing time value, a rate of pronation value, a rate of force development value, a foot strike index value, a foot orientation value, a mid-stance value, a stride length value, a stride velocity value, a joint force value, a joint moment value, or a power value.

17. The system of claim 11, wherein the at least one characteristic comprises at least one of a material hardness, a material density, a material stiffness, a material texture, a footwear shape, footwear contouring, a footwear size, a footwear component number, a footwear component size, a footwear component location, or a toebox volume.

18. The system of claim 11, wherein the one or more processors is configured to identify the at least one customization criterion to include a specified customization metric, and the specified customization metric is one of an injury risk metric, a performance level metric, and a discomfort level metric.

19. The system of claim 18, wherein
the plurality of preferred biomechanical contributing factor values are defined based on an analysis of a machine learning model trained to determine a value of the specified customization metric, wherein the analysis of the machine learning model identifies the preferred biomechanical contributing factor values as those biomechanical contributing factor values that contribute to a desired metric value of the specified customization metric;
the machine learning model is trained using training data that includes training sensor readings obtained from a plurality of training users performing one or more specified activities, wherein the plurality of users are associated with different metric values of the specified customization metric; and
the training data comprises training user anthropometric data and training user wellness data for the plurality of training users.

20. The system of claim 11, wherein the wearable device is footwear, and the footwear is an insole.
